(19) United States
(12) Patent Application Publication
(10) Pub. No.: US 2023/0223575 A1
(43) Pub. Date: Jul. 13, 2023

(54) MEMBRANE, MEMBRANE ELECTRODE UNIT, AND APPLICATIONS THEREOF

(71) Applicants: Thomas Häring, Stuttgart (DE); Davina Häring, Stuttgart (DE)

(72) Inventors: Thomas Häring, Stuttgart (DE); Davina Häring, Stuttgart (DE)

(21) Appl. No.: 17/907,914

(22) PCT Filed: Mar. 1, 2021
(86) PCT No.: PCT/IB2021/000410

§ 371 Date: Mar. 27, 2023

(30) Foreign Application Priority Data
Feb. 28, 2020 (WO) PCT/DE2020/000041

(51) Int. Cl. H01M 8/1039; H01M 8/1004; D04H 3/007; C08J 5/22

(52) U.S. Cl. CPC H01M 8/1039; H01M 8/1004; D04H 3/007; C08J 5/2293; H01M 2008/1095

(57) ABSTRACT

The invention relates to a membrane which contains crosslinked phosphonated pentafluorostyrene. The invention also relates to the use of a membrane or membrane electrodes containing crosslinked phosphonated pentafluorostyrene in an electrochemical cell at a temperature of 0 to 380° C. The invention also describes the use of a membrane or membrane electrodes containing non-crosslinked phosphonated pentafluorostyrene in an electrochemical cell at a temperature of 0 to 380° C. In addition, the invention discloses a nonwoven fabric containing phosphonated polypentafluorostyrene. The invention also relates to the use of the nonwoven fabric in a membrane or in a membrane electrode unit in electrochemical applications at temperatures up to 380° C.

### STATE OF THE ART

Fuel cells based on polymer membranes are divided into so-called low-temperature and high-temperature polymer electrolyte fuel cells. Low-temperature fuel cells, abbreviated NT-PEM in the following, have an upper reasonable operating temperature of approx. 90° C. Above this temperature, the membrane dries out faster than it is supplied with water. Above this temperature, the membrane dries out faster than water can be added to it. In addition, transport processes at the electrodes hinder a further increase in the conversion of hydrogen and oxygen. As a result, the proton conductivity and thus the performance of the NT-PEM decreases. This problem is solved by using high temperature membranes with immobilized phosphoric acid. Fuel cells with high-temperature membranes are abbreviated as HT-PEM in the following. The carrier polymer of a HT-PEM has the ability to bind phosphoric acid to itself via an ionic interaction. It is usually a polybenzimidazole (PBI), polyimidazole, anion exchange polymer or another basic polymer. Mixtures of the above polymers are also used. Proton conduction takes place via the intercalated phosphoric acid. These membranes, whether basic or with a positive charge, bind the phosphoric acid to themselves via an ionic interaction. The membrane electrode assemblies (MEA) made from them have their optimum operating temperatures in the range from 140 to 170° C. The upper temperature limit is around 210° C. Above this temperature, the phosphoric acid begins to evaporate and is discharged. Below about 120° C., these membranes absorb reaction water and subsequently the phosphoric acid (abbreviated PA) is discharged. In addition, HT-PEM has the disadvantage of requiring a significantly higher noble metal loading compared to NT-PEM. This is partly due to the coverage of the cathode catalyst with phosphoric acid. The three-phase boundary is literally flooded by the phosphoric acid. The high temperature partially opens the structures so that the catalysts can be reached by oxygen again.

The use of PA supported membranes leads to corrosion problems in the stack and limits the use of metallic bipolar plates. Only materials that are stable to phosphoric acid at the temperatures used can be used. Usually, these are graphite and graphite composites. More recent developments, e.g. from the Jülich Research Institute, also use coated stainless steels. PA is also discharged and damages other areas of the system. This includes clogging of filters, degeneration of reformer catalysts, heat exchangers, etc.

The present invention describes a polymer, solutions of the polymer, blend materials with other polymers and/or individual low molecular weight compounds, composites and membranes of the foregoing, and membrane electrode assemblies, without the use of phosphoric acid, that function at an operating temperature of 20° C. to 370° C., up to 400° C. for short periods. In addition, new applications using these materials are described.

### DESCRIPTION

The preparation of phosphonated polypentafluorostyrene is described in DE10 2011 015 212 by Kerres et.al. In this process, phosphonated polypentafluorostyrene is prepared by reaction with tris(trimethylsilyl)-phosphite followed by hydrolysis. The product obtained is phosphonated polypentafluorostyrene. The phosphonation reaction can be controlled so that only a portion of the pentafluorine units are phosphonated. In the following, phosphonated polypentafluorostyrene will be abbreviated as PWN. In the following, the number after PWN indicates the percentage of phosphonated pentafluorine units with respect to the total percentage of pentafluorine units.

Examples: The expression PWN-100 states that 100% of the pentafluorine units are phosphonated. PWN-70 states that 70% of the pentafluorine units are phosphonated. The remaining 30% of the pentafluorine units are pentafluorine units unless otherwise specified. PWN-94 states that 94% of the pentafluorine units are phosphonated, and 6% are present unmodified.

PWN-0 is an exception to the above because here all pentafluorine units are present unmodified. PWN-0 does not contain any phosphonic acid groups. It is the unmodified pentafluorostyrene. This applies, for example, to the GPC diagram for molecular weight determination in FIG. 1.

Kerres et.al, Dr. Atanasov and Yu Seung Kim have shown in recent years that this polymer has excellent anhydrous proton conductivities. Conductivities of up to 300 mS/cm at 280 to 300° C. have been demonstrated. This conductivity is nearly 300% higher than that of perfluorinated sulfonated materials, PFSA, such as Nafion®, in the fully wetted state. The proton conductivities of PFSA membranes in the fully wetted state are about 100 mS/cm.

The demonstrated temperatures of the investigated phosphonated PWN materials are around 350° C. For comparison, PBI/PA membranes have their maximum conductivity at about 165° C., and is about 110 mS/cm. Above 220° C., PBI/PA membranes are not stable. Phosphoric acid evaporates and leaves the membrane.

Below 100° C., however, PWN 100% has the problem that it is water-soluble. A membrane made of this material will dissolve at operating temperatures with liquid water occurring or will not be dimensionally stable, thus not allowing stable operation. If dissolution is not complete, then swelling and displacement due to the applied pressure in the cell is so high that the membrane-electrode assembly degrades.

However, this only applies to a PWN with a molecular weight below 100,000 grams/mol. The polymer polypentafluorostyrene is produced by free radical polymerization of pentafluorostyrene as described by Kerres et.al. In order not to obtain insoluble products or products that cannot be further processed, the polymerization is stopped at average molecular weights of about 100,000 grams/mol. It is readily possible to increase the polymerization to average molecular weights of up to 1 million and more by extending the reaction time. A comparable example is the synthesis of polystyrene. Here, molecular weights of up to 6,000,000 grams/mol have been achieved.

Batches of polypentafluorostyrene ranging from 100,000 to 2 million grams/mole have now been prepared. However, the batches have a Gaussian distribution of molecular weights. The distribution is shown in FIG. 1.

The pure PWN was then phosphonated with tris(trimethylsilyl)-phosphite as described in DE10 2011 015 212. The trimethylsilyl ester of the now phosphonated polymer is obtained first. The reaction products, the phosphonic acid ester, were insoluble gel-like, viscous masses. The batches up to about 300,000 could still be removed from the reaction vessel before hydrolysis. The higher molecular weights were further treated directly in the reaction vessel. All batches were hydrolyzed and washed over 24 hours with heated 80-90C° demineralized water. The water was changed several times.

Samples were taken and analyzed by IR spectroscopy. The resulting phosphonated polypentafluorostyrene swells very strongly, but is now no longer completely soluble even in boiling water.

The phosphonated polypentafluorostyrenes are soluble in the solvent DMSO (dimethyl sulfoxide). Above an average molecular weight of 500,000 Daltons, heating during the dissolution process is necessary or helpful. The temperature can reach the boiling point of the DMSO.

In subsequent studies, it was surprisingly discovered that water-insoluble phosphonated polypentafluorostyrenes with high molecular weights, 100,000 to 2 million grams/mole, are soluble in mixtures of water and isopropanol. The best mixtures contain 70% isopropanol and 30% water. To obtain a complete solution, batches with an average molecular weight up to 500,000 grams/mole were heated in normal vessels at the boiling point of the solvent mixture. Solutions of 5 to 8% could be prepared.

Higher average molecular weights were prepared by heating phosphonated PWN with a phosphonation level greater than 70% in demineralized water a) at a temperature of 80 to 100° C. and b) in a laboratory autoclave at 120° C. to 140° C. for 3 hours. The soluble fractions were then filtered off. The insoluble residue now had increased average molecular weights up to one million Daltons, depending on the fraction and duration of treatment in water. The maximum molecular weight was above 2.2 million Daltons.

At autoclave temperatures of 140° C. and phosphonation levels >93%, some almost completely dissolved fractions were also formed. It is assumed that a reaction with unmodified pentafluorine units to phenol units takes place due to water at the pressure.

In another embodiment, the phosphonated starting polymers were completely solubilized with alcohol-water-gem ishes as described below.

Microfiltration with ceramic membrane modules was performed with the aforementioned aqueous polymer solutions, both with alcohol and without. The membrane modules have an average exclusion limit of 200,000 to 1.5 million Daltons. Particularly preferred are the modules such as those used in beer filtration or the ceramic hollow fiber modules and the modules constructed from ceramic kappillary membranes (e.g. from the IGB in Stuttgart). Separation of the low molecular weight fractions is also successful with polymeric membranes. Successful experiments have also been carried out with flat membranes, small wound modules and hollow fiber modules. However, these have the disadvantage that they entail a limitation in a subsequent purification. The ceramic modules, whether ceramic fiber, ceramic disk or tubular module in rod design, can be subjected to pressures up to 8 bar and temperatures up to 200° C. In addition, they are suitable for mixtures containing alcoholic solvents or organic solvents, especially aprotic solvents such as dimethyl sulfoxide, DMAc or NMP, with mixtures containing DMSO being preferred. Larger exclusion limits than 1.5 million daltons are also possible. However, this has the disadvantage that the proportion of the remaining polymers becomes uneconomically small.

The non-permeating residue is evaporated and later further processed. The obtained average molecular weights of the phosphonated polymer are now between 500,000 and two million Daltons, depending on the module and solvent mixture used.

To bring the larger molecular weights of phosphonated polypentafluorostyrene into aqueous/alcohol solution was carried out in a laboratory autoclave, a pressure vessel. All polymers previously insoluble in water could be completely dissolved in the isopropanol-water mixture in two hours in the autoclave. The temperature in the autoclave ranges from 82° C. to a maximum of 140° C., depending on the mixing ratio of isopropanol and water. The alcohol-water mixing ratios used are from 5% wt. alcohol to 80% wt. of alcohol. lsopranol has proven to be the most economical alcohol. Alcohol-water mixtures with ethanol, methanol, n-propanol and higher alcohols up to n-pentanol and their respective isomers are also possible. The higher boiling alcohols are preferred when very high molecular weights above 2 million Daltons are to be dissolved. In this case, the boiling temperature can be increased accordingly. The higher alcohols and mixtures with lower alcohols containing them are preferred if the degree of phosphonation of PWN is below 70% wt.

The resulting solutions were purified by filtration of insoluble residues and particles. Complete solutions were obtained by using solvent mixtures containing additional aprotic polar solvents. DMSO, NMP and DMAc were particularly preferred.

In further experiments, it was found that other water-alcohol mixtures are also suitable for dissolving the phosphonated polypentafluorostyrenes. Methanol, ethanol, propanol, butanol and their isomers were used as alcohols.

All the aforementioned solutions concern PWN-70 to PWN-98.

The solutions were now processed into membranes using various methods. These include electrospinning, inkjet, casting and dipping processes. All processes were carried out with and without a carrier material. Suitable support materials or reinforcement materials are ceramic fibers such as glass fibers, boron nitride fibers, aerogel materials both in powder form and sheet form.

Stretched PTFE and ETFE were used as polymeric support material. Two different types of materials were used: stretched and oriented PTFE and ETFE as used for breathable materials, with a pore size of >0.5 μm, especially >0.8 μm and a thickness of 7 μm to 250 μ, especially preferably 15 μm to 50 μm. And PTFE or ETFE fabric in the specified thicknesses. Particularly preferred is the use of hydrophilized carrier fabric. This is a fluorinated fabric that facilitates the penetration of aqueous, in particular aqueous-alcoholic solutions. Hydrophilized PTFE or ETFE fabric and flat films with the above pore size are commercially available from a large number of manufacturers.

PWN with a degree of phosphonation greater than 60% is very brittle in the anhydrous state, especially PWN-80 and above. PWN-94 and higher PWN up to PWN-100, for example, break on contact and are thus unsuitable as a free-supporting membrane. It has now been shown that by means of a glass fiber reinforcement, but especially by means of a glass fiber membrane, these PWN can be processed into a membrane.

Particularly preferred are support membranes that have a honeycomb perforated structure in the broadest sense. The honeycomb structure is the ideal formation. Such carrier materials are, for example, ion track membranes. Suitable carrier materials are polyimides, polyetherketones, polysulfones and polybenzimidazoles. The support materials polyimide and polybenzimidazole are preferred. The open area of the materials is 40 to 80%, with the range greater than 60% being preferred. The support materials are filled with the phosphonated polymer by casting, optionally with pressure or vacuum. The solvent is removed by evaporation and then the resulting membrane filled with PWN-80 to PWN-100 is still coated on both sides by spraying with a thin PWN-80 to PWN-100 layer.

A particular embodiment is the additional admixture of finely ground or freshly precipitated bentonites, zeolites and nanoscale silicate and nanoscale silica to the aqueous alcoholic solution of the polymers. The proportion of silicates based on the mass fraction of the polymer is 0.3% to 20% by weight.

It has been shown that the incorporation of the silicates is of great advantage in later operation and lowers the hydrogen permeability of the membrane after heating to temperatures of up to 380° C. This was measured by the open-circuit voltage. This was measured by the open circuit voltage after a temperature rise from 20° C. to 300° C. and then in steps to 380° C.

The open-circuit voltage without the silicate admixtures in the polymer drops from the original 850 mV to 400 mV after heating to 320° C., lowering to 50° C. and reheating to 260° C. With the addition of 2 to 10% of nanoscale acidic bentonite, zeolite, nanoscale silica in PWN, the open circuit voltage remained at 750 mV at a temperature of 260° C.

All the membranes obtained were no longer soluble in water at temperatures up to 50° C. after removal of the solvent mixture, especially the respective alcohol.

Phosphonic acid group-containing low molecular weight or high molecular weight compounds based on pentafluorostyrene compounds allow very high ion exchange capacities (IEC) and thus high proton conductivities. An inherent disadvantage is the salt-like structure of the materials. That is, high IEC leads to high proton conductivity and this is necessarily accompanied by mechanical instability. For example, PWN-94 as a membrane is so brittle in the dried state that even the slightest mechanical stress will cause the material to break. This also applies to glare materials, which are predominantly made of PWN-94. This problem can only be solved to a limited extent by increasing the molecular weight. Surprisingly, it has now been found that fibers made from PWN-80 to PWN-94 produced via electrospinning or centrifuge spinning are mechanically stable even in the dry state. Dry means that the fiber is heated at 130° C. to constant weight. The fiber then releases any water it contains. It can then be bent without breaking, and is no longer brittle. As the molecular weight increases, the properties of the fibers improve. From an average molecular weight of 200,000 Daltons, mechanically stable nonwovens are obtained that are no longer brittle in the dry state. To produce mechanically stable PWN-containing membranes, fibers were prepared via the electrospinning process. Surprisingly, it was found that solutions of PWN-60 to PWN-70 in water-isopropanol mixtures did not form fibers. A very fine dust-like powder was formed. The same result was obtained in experiments with a centrifuge spinning device. The water-isopropanol content was 50% in each solvent mixture. The content of the respective PWN was 3 to 10%. However, it is surprisingly found that the use of PWN with a phosphonation content of more than 85% leads to distinct long fibers up to a length of 20 cm. The use of PWN-90 and above is particularly preferred. The best fibers were obtained when PWN-94 was used. The isopropanol-water solution had 50% each of isopropanol and water. The weight percentage of PWN-94 in the solution ranged from 6 to 10% wt. in the experiments. The fibers obtained have a median diameter of 100 to 200 μm. The special feature is that these fibers do not break in the dry state. They are flexible like glass fibers.

PWN-94 fibers with molecular weights of 100,000 to 2 million daltons of the starting polymer were carefully calendered to a thickness of 10 μ. to 30 μ. Basis weights of 8 grams to 40 grams/m² were achieved.

EDX, FTIR and electron microscopic studies of the fiber surface partially elucidated the effect. During the flight phase, the hydrophobic and hydrophilic parts of the molecules align. The hydrophobic regions are located in the inner region of the fiber and the phosphonic acid groups are located on the surface of the fiber. The mechanically unstable salt-like structure of the phosphonic acid groups is now opposed by an ordered, mechanically stable alignment of the hydrophobic portions of the polymer. Why PWN fibers in particular with the The fact that the nonwovens with the highest phosphonic acid group contents are the most stable cannot yet be explained.

The nonwovens described above are now filled with other polymers in a further step. Sulfonated polymers, phosphonated polymers and/or unmodified polymers are used. Stable nonwovens that do not break under load in the dry state can be produced with this process. The nonwovens contain PWN-60 to PWN-100, and nonwovens with PWN-80 to PWN-96 are particularly preferred. These can now be filled as desired with other materials, such as polymers or low-molecular compounds. The nonwovens themselves are highly proton conductive and suitable for processing or incorporation into a gas diffusion layer or electrode. The only constraint to be considered is that no solvent is used in the modification that is suitable to redissolve the fleece of phosphonated PWN. Alcohols, water and DMSO are therefore unsuitable for this step. THF, DMAc or NMP are suitable.

In one embodiment, a 30 μ thick PWN-94 nonwoven web consisting of fibers with a median cross-section up to 300 μ is filled with sulfonated polyether ketone-ether ketone. The process chosen was an injection jet process and the polymer has an IEC of 2.3 and is present as an aqueous solution.

In another embodiment, the PWN-94 nonwoven was coated with the sulfochlorinated polyetherketone-ether-ketone-ketone using a spray method from a paint gun. The solvent for the sulfochlorinated polyether ketone is tetrahydrofuran.

Both membranes were dried, with the latter subsequently hydrolyzed in a water vapor atomosphere for 24 hours at 90° C.

Both membranes were calendered to a membrane of 20 to 25 μ thickness and processed to a MEE using the electrodes listed below. The membranes themselves are stable even in the dry state and show no rupture in 90° buckling tests even in the water-free state. In other words, the membranes were folded once and do not break. The comparative samples of PWN-94 materials, where the polymer has no fiber state, with the sulfonated polymers listed above are not processable into a membrane. And even if blends can be made, they break immediately in the anhydrous state at the slightest stress.

With these membranes, power values of up to 1100 mW/cm² were achieved in the fuel cell at 260° C. under the conditions listed below.

The condition for the materials prepared by electrospinning: 35 to 65 kV via a syringe device on a) commercial gas diffusion electrodes and b) aluminum foil. The concentration of PWN-94 in the isopropanol-water solutions is 2 to 6% wt. Any alcohol-water mixtures can be prepared, but the water content is preferably below 40% wt. The best and safest alcoholic solvent to water in the experiments so far is isopropanol.

The alcohols used are ethanol, methanol, propanol and isopropanol. The alcohol concentration is between 15% and 90% wt. The rest of the solvent mixture is demin. Water.

Phosphonated PWN cannot be blended with other non-fluorinated polymers under known conditions. Example: No blends with sulfonated polyether ketones or sulfonated polysulfones can be prepared. During the solvent evaporation process, separation of the polymers occurs. However, it would be of great advantage to be able to combine these polymers to homogeneous materials. As already mentioned, PWN with a phosphonation content of >50% is very salt-like and brittle and does not form a stable load-bearing membrane by itself. By adding a second polymer, this disadvantage can be overcome. This works, for example, by adding polybenzimidazole (PBI). However, PBI has the disadvantage that the proton conductivity is reduced.

Sulfonated or even phosphonated other polymers, such as polyetherketones or polysulfones would improve the mechanical properties.

It is possible to produce a stable membrane by electrospinning the individual components in separate individual syringes or individual centrifuges. Nanofibers are produced by centrifuge spinning using the process from the Textile Research Institute in Denkendorf (DE). This results in two types of nanofibers deposited on the same target (gas diffusion electrode or aluminum foil). The fibers mix in the flight phase and form a common dense nonwoven. In a subsequent calender or in a hot press, the nonwoven is compressed into a gas-tight membrane. For sulfonated or phosphonated polyether ketones and polysulfones, the compression temperature is 160 to 230° C. The temperature range of 200 to 210° C. is particularly preferred. The pressure depends on the thickness of the desired final membrane and the thickness of the starting viscose.

In one embodiment, the nonwoven of phosphonated PWN-94 is sprayed with sulfonated polymers dissolved in DMAc or NMP. Sulfonated poly-ether-ketone-ether-ketone with an IEC ovn 1.86 meq/gram and a molecular weight of 47,000 daltons of the sulfonated polymer were used. The procedure was carried out on both sides, if necessary. Then the nonwoven impregnated with sulfonic acid was carefully callandred. The callander has a PTFE coating. The obtained membrane had anhydrous proton conductivity up to 280° C. The membrane was processed into a MEA with electrodes of 1.5 mg/cm² noble metal each. The obtained power at 280° C. was 420 mW/cm² at 1.5 bar hydrogen and air.

Another method like the previously described method for improving mechanical stability is reinforcement with silicate fabric and silicate fibers or glass fabric and glass fibers. In a particular embodiment, silicate aerogel and boron nitride aerogel are used.

### Example

4) PWN-94 is dissolved in 70% isopropanol and 30% water. The concentration is 5% wt. Glass fiber nonwoven with 16 microns thickness is coated with the solution on both sides.

Helpfully, the coating takes place between two PTFE films. After evaporation of the solvent, the gas tightness is checked by keeping constant 100 mbar absolute pressure with air. If there are any flaws, the process is repeated.

5) Add 3% wt (based on PWN mass) of acidic montmorrilonite to the PWN-94 solution from Example 4.

6) Add 3% wt (based on PWN mass) zeolite type: ZSM 5 or ZSM 11 in acid form to the PWN-94 solution from example 4.

7) Add 3% wt (based on PWN mass) of powdered glass fiber to the PWN-94 solution from Example 4.

All membranes were tested from the examples in a heated conductivity cell using a Zahner impedance meter. The conductivity was recorded up to 380° C. Above a temperature of 370° C. the membrane started to decompose. Attached is the TGA of the pure PWN-94 material.

The conductivity increases continuously from 160° C. up to 350° C. Above this temperature, the values become inaccurate. The highest values were measured for the membranes from examples 5) and 6).

### Conductivity Values:

250° C.=260 mS/cm; 280° C.=300 mS/cm; 300° C.=320 mS/cm; from 340° C. the values decrease until at 380° C. the membrane starts to degenerate.

The membranes from examples 5) to 7) were platinum-containing electrodes applied via ink application on both sides and the performance was measured.

The obtained performances are in peak at 1100 mW at 300° C., and 1.5 bar of air enriched with oxygen to 30%.

The membrane from example 7 showed only a very low power, which then failed completely.

These high operating temperatures and outputs allow completely new applications. For example, direct reforming of methanol-water mixtures is now possible. This can be achieved in two ways. Either the heat from a fuel cell is extracted via thermal oil and fed to a separate reformer, or the reforming takes place directly in the metallic bipolar plate. For this purpose, the metallic bipolar plate, which has an internal liquid guide, is coated on the inside with reforming catalysts. Such bipolar plates, without the catalysts, are offered by Gräbener or Borrit. The internal coating with the reforming catalysts can be carried out subsequently in the so-called wash-coat process or already before the two holders are welded together. Instead of methanol-water mixtures, dehydrogenation of LOHC (+) storage liquids (e.g. hydrogenated dibenzyltoluene, 18H-DBT) can also be carried out in the metallic bipolar plate.

The dehydrogenation temperature is between 250° C. and 350° C.

In one embodiment, such a fuel cell is operated, optionally with hydrogen, with methanol-water mixture or with LOHC(+) storage fluids.

Preferred is the temperature range from 260° C. to 320° C.

As another solution to the problem of crosslinking, especially the low molecular weight moieties of phosphonated polypentafluorostyrenes, it was proposed by Kerres and Atanasov to blend PWN 100% with a few percent PBI. However, this has the disadvantage of reducing the remaining phosphonic acid groups. In addition, the ionic blend builds up positive countercharges in the membrane. These increase the resistance to such an extent that the resulting MEE has a poorer performance than a comparable PBI/PA MEE.

In the present invention, the problem of water solubility of PWN 100% or 90% to 100% has been solved by not fully phosphonating polypentafluorostyrene (PFS). This is accomplished by at least two different routes. The phosphonation reagent is used in an under-supplied state, or the phosphonation reaction is monitored (e.g., by concomitant IR analysis of samples) and then stopped at the desired value. The reaction itself takes place at 160-170° C. for 1-24 hours, especially preferably for 5 to 8 hours in reflux and is therefore easily stopped by cooling. Products ranging from PWN 10% to PWN 100% were obtained after hydrolysis. The phosphonated fraction is determined by ATR-IR analysis of drawn samples. Hydrolysis of the phosphonic acid ester is virtually instantaneous by treatment of the ester in heated water, preferably by reflux heating.

PWN 70% still has 30% remaining pentafluorostyrene units. These are now crosslinked using nucleophilic reagents. Several routes were used for this.

Phosphonated polypentafluorostyrene becomes increasingly brittle in the anhydrous state as the degree of Phsophonation increases. PWN greater than approx. 75% phosphonation, i.e. >PWN-70, is brittle in the anhydrous state and not suitable for a gas-tight membrane as required in the fuel cell. Fabric reinforcement does not solve the problem.

A membrane with >90% phosphonated content has such a high group density of phosphonic acid groups that they lead to a salt-like structure. Anhydrous films of this type are not mechanically stable. To solve the problem, bisphenol-A and bisphenol-AF were modified into nucleophilic reagents for crosslinking so that they can be used as vulcanization aids. The vulcanization aids from DE1998144681 were used for this purpose. The following examples demonstrate the use of bisphenol AF/quaternary phosphonium salts for the crosslinking of phosphonated polypentafluorostyrenes. The weight ratios given are exemplary and not limiting.

The following are the examples for the modification of bisphenol AF:

### Example 1

16.80 g (50 mmol) of bisphenol AF (BAF) and about 15 g of methanol were added to a reaction vessel with a volume of 500 ml under stirring at 50° C., yielding a solution. Then, 2.70 g (50 mmol) of sodium methoxide was added to the solution, followed by stirring for 15 minutes to form a solution containing bisphenol AF monosodium salt. A solution containing 20.20 g (52 mmol) of benzyl triphenylphosphonium chloride (BTPPC) in about 15 g of methanol was then added, followed by stirring for 15 minutes to obtain a solution A containing a reaction mixture of one mole of BAF with 1.04 moles of BTPPC in methanol ([BAF-1.04 BTPP]/MeOH).

To the methanol solution (A) was added a solution containing 50.40 g (150 mmol) of BAF in approximately 45 g of methanol, followed by stirring for 15 min to obtain a methanol solution B containing a reaction mixture of 4 mol of BAF with 1.04 mol of BTPPC ([4BAF-1.04 BTPP]/MeOH).

The resulting methanol solution B was concentrated in an evaporator to a residue of about 30%, and the resulting concentrate was slowly added dropwise to 41 of water within 60 minutes with stirring, which removed the by-product NaCl and caused the reaction mixture to crystallize and precipitate, followed by washing with water, renneting (decantation or filtration), and drying (at 40° C. in a vacuum dryer for 20 hours or longer). The resulting vulcanization aid (melting point: 58° C.) was stored in a tightly closed container.

### Example 2

35.18 g of [BAF-1.04 BTPP] (corresponding to a mixture of 50 mmol of the reaction mixture with 2 mmol of unreacted BTPPC) obtained from the methanol solution A of Example 1 ([BAF-1.04 BTPP]/MeOH) by applying the same steps to constriction to dryness as used for the methanol solution B in Example 1, and 30 g of methanol were introduced into a reaction vessel having a volume of 500 ml and stirred at 50° C., thereby obtaining a solution. Then, a solution containing 50.40 g (150 mmol) of BAF in about 45 g of methanol was added to the resulting solution, followed by stirring for 15 minutes, resulting in a methanol solution containing a reaction mixture of 4 moles of BAF with 1.04 moles of BTPPC ([4BAF-1.04 BTPP]/MeOH).

Then the methanol solution was subjected to the same sequence of concentration, crystallization and precipitation, washing with water, separation and drying as in Example 1, and the resulting vulcanization aid (melting point: 58° C.) was stored in a tightly closed container.

### Example 3

16.80 g (50 mmol) of bisphenol AF (BAF) and about 15 g of methanol were added to a reaction vessel with a volume of 500 ml under stirring at 50° C., obtaining a solution. Then 5.40 g (100 mmol) of sodium methoxide was added to the solution, followed by stirring for 15 minutes to form a solution containing bisphenol AF disodium salt. Then, a solution containing 40.40 g (104 mmol) of BTPPC in about 30 g of methanol was added, followed by stirring for 15 minutes to obtain a methanol solution containing a reaction mixture of one mole of BAF with 2.08 moles of BTPPC ([BAF-2.08 BTPP]/MeOH).

A solution containing 117.60 g (350 mmol) BAF in approximately 105 g methanol was added to the resulting methanol solution, followed by stirring for 15 min, yielding a methanol solution containing a reaction mixture of 4 moles BAF with 1.04 moles BTPPC ([4BAF-1.04 BTPP]/MeOH).

Then the methanol solution was subjected to the same sequence of concentration, crystallization and precipitation, washing with water, separation and drying as in Example 1, and the resulting vulcanization aid (melting point: 58° C.) was stored in a tightly closed container.

### Example 4

The sequence of addition of the methanolic BAF solution and the methanolic BTPPC solution used to form methanol solution A in Example 1 was reversed. The resulting vulcanization aid (melting point: 58° C.) was stored in a tightly closed container.

### Example 5

67.20 g (200 mmol) of bisphenol AF (BAF) and approximately 60 g of methanol were added to a reaction vessel with a volume of 500 ml under stirring at 50° C., yielding a solution. Then 2.70 g (50 mmol) of sodium methoxide was added to the solution, forming ¼ sodium salt of bisphenol AF. Then a solution containing 20.20 g (52 mmol) (BTPPC) in about 15 g methanol was added, followed by stirring for 15 minutes to obtain a methanol solution containing a reaction mixture of 4 mol BAF with 1.04 mol BTPPC in methanol ([4BAF-1.04 BTPP]/MeOH).

Then the methanol solution was subjected to the same sequence of concentration, crystallization and precipitation, washing with water, separation and drying as in Example 1, and the resulting vulcanization aid (melting point 58° C.) was stored in a tightly closed container.

### Example 6

16.80 g (50 mmol) of BAF, 20.20 g (52 mmol) of BTPPC, and approximately 45 g of methanol were introduced into a reaction vessel with a volume of 500 ml with stirring at 50° C., yielding a solution. Then, 2.70 g (50 mmol) of sodium methoxide was added to the solution, followed by stirring for 15 minutes, obtaining a methanol solution containing a reaction mixture of 1 mol of BAF with 1.04 mol of BTPPC ([BAF-1.04 BTPP]/MeOH).

To the methanol solution was added a solution containing 50.40 g (150 mmol) of BAF in approximately 45 g of methanol, followed by stirring for 15 min, yielding a methanol solution containing a reaction mixture of 4 mol of BAF with 1.04 mol of BTPPC ([4BAF-1.04 BTPP]/MeOH).

Then the resulting methanol solution was subjected to the same sequence of constriction, crystallization and precipitation, washing with water, separation and drying as in Example 1, and the resulting vulcanization aid (melting point: 60° C.) was stored in a tightly closed container.

### Example 7

16.80 g (50 mmol) of BAF and approximately 15 g of methanol were placed in a reaction vessel with a volume of 500 ml, and then 2.80 g (50 mmol) of potassium methoxide was added, followed by stirring at 50° C. for 15 minutes to form a solution containing a monopotassium salt of bisphenol AF. Then a solution containing 20.20 g (52 mmol) of BTPPC in about 30 g of methanol was added, followed by stirring for 15 minutes to obtain a methanol solution containing a reaction mixture of 1 mol of BAF with 1.04 mol of BTPPC ([BAF-1.04 BTPP]/MeOH).

To the methanol solution was added a solution containing 50.40 g (150 mmol) of BAF in approximately 45 g of methanol, followed by stirring for 15 min, yielding a methanol solution containing a reaction mixture of 4 mol of BAF with 1.04 mol of BTPPC ([4BAF-1.04 BTPP]/MeOH).

Then the resulting methanol solution was subjected to the same sequence of constriction, crystallization and precipitation, washing with water, separation and drying as in Example 1, and the resulting vulcanization aid (melting point: 60° C.) was stored in a tightly closed container.

### Examples 8 To 14

Example 8-1: 100 parts by weight of a phosphonated polypentafluorostyrene having a phosphonic acid content of 60% -70% as potassium or sodium salt, 5 parts by weight of calcium hydroxide, 3 parts by weight of magnesium oxide and 2 parts by weight of one of the vulcanization aids (4BAF-1.04 BTPP) obtained in Examples 1 to 7 were kneaded through an open roll at a temperature of up to 80° C. Then rolled out into a film with a film thickness of 20 microns to 500 microns, with 50 to 100 microns being preferred. The films were then subjected to press vulcanization at 180° C. for 15 minutes and then oven vulcanization (secondary vulcanization) at 230° C. for 22 hours.

Example 8-2: 100 parts by weight of a phosphonated polypentafluorostyrene having a phosphonic acid content of 75% -95% as potassium or sodium salt, 5 parts by weight of calcium hydroxide, 3 parts by weight of magnesium oxide, and 2 parts by weight of one of the vulcanization aids (4BAF-1.04 BTPP) obtained in Examples 1 to 7 were kneaded through an open roll at a temperature of up to 80° C. Then rolled out into a film with a film thickness of 20 microns to 500 microns, with 50 to 100 microns being preferred. The films were then subjected to press vulcanization at 180° C. for 15 minutes and then oven vulcanization (secondary vulcanization) at 230° C. for 22 hours.

Example 9-1: 100 parts by weight of a phosphonated polypentafluorostyrene having a phosphonic acid content of 60% to 70% as potassium or sodium salt, 50 parts by weight of N-methylpyrrolidone or dimethylacetamide or dimethyl sulfoxide, and 2 parts by weight of one of the vulcanization aids (4BAF-1.04 BTPP) obtained in Examples 1 to 7 were kneaded through an open roll at a temperature of up to 80° C. Then rolled out into a film with a film thickness of 20 microns to 500 microns, with 50 to 100 microns being preferred. The films were then subjected to oven vulcanization (secondary vulcanization) at 230° C. for 22 hours. The solvent and the released hydrogen fluoride were bound in an exhaust air filter unit.

Example 9-2: 100 parts by weight of a phosphonated polypentafluorostyrene having a phosphonic acid content of 75% to 95% as potassium or sodium salt, 50 parts by weight of N-methylpyrrolidone or dimethylacetamide or dimethyl sulfoxide, and 2 parts by weight of one of the vulcanization aids (4BAF-1.04 BTPP) obtained in Examples 1 to 7 were kneaded through an open roll at a temperature of up to 80° C. Then rolled out into a film with a film thickness of 20 microns to 500 microns, with 50 to 100 microns being preferred. The films were then subjected to oven vulcanization (secondary vulcanization) at 230° C. for 22 hours. The solvent and the released hydrogen fluoride were bound in an exhaust air filter unit.

Example 9-3: 100 parts by weight of a phosphonated polypentafluorostyrene having a phosphonic acid content of 60% to 70% as potassium or sodium salt, 70 parts by weight of N-methylpyrrolidone or dimethylacetamide or dimethyl sulfoxide, and 2 parts by weight of one of the vulcanization aids (4BAF-1.04 BTPP) obtained in Examples 1 to 7 were kneaded through an open roll at a temperature of up to 80° C. Then rolled out into a film with a film thickness of 20 microns to 500 microns, with 50 to 100 microns being preferred. The films were then subjected to oven vulcanization (secondary vulcanization) at 230° C. for 22 hours. The solvent and the released hydrogen fluoride were bound in an exhaust air filter unit.

Example 9-4: 100 parts by weight of a phosphonated polypentafluorostyrene having a phosphonic acid content of 75% to 95% as potassium or sodium salt, 70 parts by weight of N-methylpyrrolidone or dimethylacetamide or dimethyl sulfoxide, and 2 parts by weight of one of the vulcanization aids (4BAF-1.04 BTPP) obtained in Examples 1 to 7 were kneaded through an open roll at a temperature of up to 80° C. Then rolled out into a film with a film thickness of 20 microns to 500 microns, with 50 to 100 microns being preferred. The films were then subjected to oven vulcanization (secondary vulcanization) at 230° C. for 22 hours. The solvent and the released hydrogen fluoride were bound in an exhaust air filter unit.

All films shown were insoluble in water after oven vulcanization. They showed increasing swelling behavior with increasing initial phosphonic acid content. At phosphonic acid levels of 70 to 80%, no dissolution could be observed even in boiling water at a temperature of 95° C. to 100° C. The control of 80% phosphonic acid content dissolved or disintegrated into many small pieces.

A MEE of 5 cm² was made from each of the crosslinked membranes from the examples and from the membranes made with PWN nonwoven and cycled in a temperature window from 40° C. to 250° C., with a full cycle lasting 6 hours in each case. After 30 cycles, no noticeable degeneration was evident in the MEA containing the nonwoven, with a 4% decrease in the first 5 cycles. The electrodes were applied and had a loading of 0.6 milligrams/cm² Pt (cathode) and 0.5 milligrams/cm² Pt-Ru on the anode. Readings were taken in H2/O2 at 1.5 bar absolute. A peak power of 1.2 watts/cm² was obtained.

Another MEE was fabricated from the cross-linked PWN 70% described above and heated to 300° C. Operation was with air, instead of pure oxygen. At 300° C., 1.1 watt power/cm² was obtained.

Use of crosslinked PWN 70% membrane in direct reforming methanol-water fuel cell (IRMFC).

20 crosslinked PWN 70% membranes were processed to MEEs with commercial gas-diffusion electrodes containing 1.2 mg Pt (cathode) and 1.5 mg PT-Ru (anode). The MEEs were installed in a stack of 20C40R from ZBT in Duisburg instead of the previously used MEE and operated as published in the report FCH JU Grant Agreement number: 325358 with the project acronym: IRMFC.

Then 32 MEEs were operated in the 32 MEA stack with metallic bipolar plates at temperatures from 40° C. to 230° C. In the temperature range below 200° C., hydrogen was additionally dosed. In the previous setup with PBI phosphoric acid membranes, no more than 10 start-stop cycles could be operated in the IRMFC.

With the new MEE made of the cross-linked PWN membranes, more than 100 start-stop cycles have been operated in the system with the 20C40R type stack so far, and more than 200 start-stop cycles have been operated in the cell from the 20C40R type system.

The new cross-linked membranes and the MEEs made from them have many advantages. They allow high-temperature fuel cells to operate in a temperature range below 100° C. Condensed out water in the cell is not harmful. In addition, phosphoric acid is no longer discharged, which in turn allows the use of metallic bipolar plates. Up to now, graphitic bipolar plates have been used almost exclusively. The use of metallic bipolar plates now allows the cooling of the stack to be conducted through the bipolar plates. In NT-PEM this is already standard. The high temperature stability of the new MEE allows operation up to 350° C. Short-term operation up to 380° C. has been demonstrated. The problem at temperatures above 320° C. is seal failure and degradation of fluorine compounds in the stack that are not directly part of the polymer. The high operating temperatures above 200° C. now allow direct reforming of methanol-water-vapor mixtures upstream and/or directly on the anodic side of the MEE.

In a particular embodiment, the reforming takes place within the metallic bipolar plate. This area is used in the NT-PEM (low-temperature PEM) only for waser-guided cooling.

1. A membrane comprising crosslinked phosphonated pentafluorostyrene.

2. The membrane according to claim 1, wherein a proportion of phosphonated pentafluorostyrene units in the polymer is between 2-98% wt. and the proportion of crosslinked pentafluorostyrene units is between 98-2% wt.

3. The membrane according to claim 1, wherein a proportion of phosphonated pentafluorostyrene units is in the range of 60 to 85% wt.

4. The membrane according to claim 1, wherein a nucleophile is used as crosslinking reagent.

5. The membrane according to claim 4, wherein the nucleophile comprises a functional group, being one or more of: phosphonic acid and/or and sulfonic acid.

6. A membrane electrode assembly comprising the crosslinked phosphonated membrane of claim 1.

7. The membrane electrode assembly of claim 6, being provided in a fuel cell at a temperature of 0° C. to 380° C.

8. A membrane comprising phosphonated pentafluorostyrene, that is fabric-reinforced or and/or fiber-reinforced in an electrochemical cell at a temperature of 0 to 380° C.

9. A nonwoven material comprising phosphonated polypentafluorostyrene.

10. The nonwoven material of claim 9, wherein the phenyl ring (PWN) is phosphonated.

9. The nonwoven material of claim 9, wherein the phosphonation is between 1 to 100%.

12. The nonwoven material of claim 9, wherein the nonwoven material further comprises an additional polymer, a low molecular weight compound, or a mixture thereof.

13. The nonwoven material of claim 12, wherein the additional polymer or the low molecular weight comprises a functional group derived from one or more of: sulfonic acid and phosphonic acid.

14. A dense, proton-conducting membrane comprising the non-woven material of claim 12.

15. The non-woven material of claim 13, provided in a membrane or in a membrane-electrode assembly at a temperature between 260° C. and 380° C.

16. The non-woven material of claim 15, wherein the temperature is below 300° C.

17. The membrane of claim 7, wherien the temperature ranges between 20° C. and 280° C.

18. The non-woven material of claim 11, wherein each phenyl ring in the polymer is phosphonated.
